(19) United States
(12) Patent Application Publication
(10) Pub. No.: US 2016/0309729 A1
(43) Pub. Date: Oct. 27, 2016

(54) METHOD AND DEVICE FOR PROCESSING RAW MATERIALS AND EFFECTIVELY PRODUCT MEAT- AND SAUSAGE-BASED RAW CURED GOODS

(71) Applicants: DEUTSCHES INSTITUT FÜR LEBENSMITTELTECHNIK E.V., Quakenbrück (DE); TRITON GMBH, Berlin (DE)

(72) Inventor: Fritz Kortschack, Berlin (DE)

(73) Assignee: DEUTSCHES INSTITUT FÜR LEBENSMITTELTECHNIK E.V., Quakenbrück (DE)

(21) Appl. No.: 15/035,127

(22) PCT Filed: Sep. 17, 2014
(86) PCT No.: PCT/EP2014/069779

§ 371 Date: May 6, 2016

(30) Foreign Application Priority Data
Nov. 11, 2013 (DE) 10 2013 018 863.6

(51) Int. Cl. A23B 4/033; A23B 4/22; A23B 4/03; A23L 13/60; A23B 4/015

(52) U.S. Cl. CPC A23B 4/033; A23L 13/65; A23B 4/015; A23B 4/031; A23B 4/22; A23V 2002/00

(57) ABSTRACT

The invention relates to a method and to a device for processing raw materials and effectively producing meat- and sausage-based raw cured goods by means of a drying and aging process together with the addition of starter cultures, wherein the raw material or an already available intermediate product is exposed to a vacuum. According to the invention, moisture, in particular water or water vapor, released during the treatment under vacuum is bound by means of adsorbents in order to accelerate the drying process, wherein the adsorption process occurs in one or more stages depending on the desired degree of drying or the a_{w} value of the raw material or intermediate product.

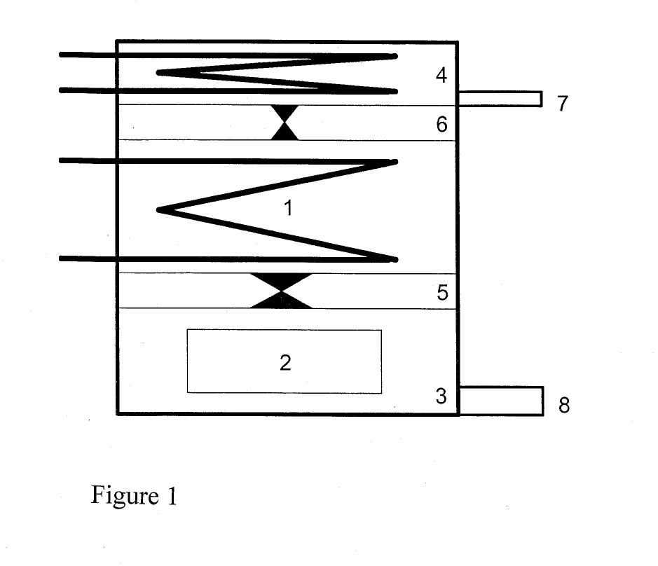

The invention relates to a method for processing raw materials and effectively producing raw cured goods on the basis of meat and sausage by means of a drying and ageing process together with the addition of starter cultures, wherein the raw material or an already available intermediate product is exposed to a vacuum, and to a pertinent device according to the preamble of claims 1 and 7.

Production techniques are often applied especially in the meat product industry whose processing steps ultimately lead to a reduction in the quality of the end product and are characterized by high energy consumption. Reference shall be made in this respect to the production of scalded-emulsions sausages, which are heated, cooled, heated and cooled again in stages.

Especially the use of freeze-dried meat requires contradictory conditions during the production of the raw material, which lead to increased costs and burdens on the raw material substance. It was recognised that as a result of freeze-drying it is not possible to obtain and maintain the desired complete colour and protein potential for the production of the raw sausage. The frequently observed oxidation of fat components in particular cannot be avoided entirely.

On the basis of the aforementioned statements, it is therefore the object of the invention to provide a further developed method and a pertinent device for the processing of raw material and effectively producing raw cured goods on the basis of meat or sausage by means of a drying and ageing process together with the addition of starter cultures, wherein the raw material or an already available intermediate product is exposed in the known manner to a vacuum. The actual drying step should then be realisable in such a way that the initial water activity (a_{w} value) which is necessary for ageing can be achieved without a freezing process, this being without oxidation phenomena occurring or without the colour and protein potential no longer being available in the desired manner for the success in achieving a high-quality finished product.

The object of the invention is achieved by the method by the teachings according to claim 1 and by the device with the feature combination according to claim 7, wherein the dependent claims at least represent appropriate embodiments and further developments.

According to the invention, such an amount of water is extracted under vacuum from the raw product, and especially the fresh meat, by means of adsorbents that the a_{w} value of the total mixture reaches such a value that the starter cultures can become effective in the subsequent treatment or production process and the required biochemical processes can proceed in an undisturbed manner.

The employed adsorbents such as silica gel or zeolite show a high water-binding capacity under vacuum and can be used in a respective device in accordance with the invention.

Accordingly, during the treatment under vacuum, released moisture, especially water or water vapour, is bound by means of adsorbents for accelerating the drying process of the raw material or an already available intermediate product, wherein the adsorption process, depending on the desired degree of drying or the a_{w} value of the raw material or intermediate product, progresses in one or several steps.

The regeneration of deployed adsorbents can preferably be provided by utilising exhaust heat from the subsequent raw material process treatment steps in an energy-saving manner.

Released condensation and adsorption heat can be used for the careful heating of the raw material or the intermediate product.

In one embodiment of the invention, the raw material or the intermediate product can partly be surrounded by a covering in order to produce selective drying and selective extraction of moisture.

In a preferred solution in accordance with the invention, meat for example is introduced as a treatment material into a double-wall vacuum tumbler or vacuum mixer. The treatment material is shifted regularly in order to ensure constant drying. In order to initiate the drying process at this point, a vacuum is drawn into the tumbler or mixer. Moisture is extracted from the meat by applying a respective vacuum. The energy concept in accordance with the invention consists of utilising the evaporation cooling produced during the vacuum extraction for cooling the hygroscopically acting adsorbents. The heating of the adsorbents with the consequence of a reduced efficiency is counteracted in this respect. Heat is produced in the deposit of the moisture in the adsorbents of a deployed adsorber. This heat is used for heating the double-wall vacuum container. The treatment material is simultaneously heated by the heating of the container, leading to a more rapid discharge of water from the treatment material.

As a result of the water evaporating from the treatment material, the treatment material is cooled as a result of the evaporation cooling. The vapour pressure decreases with decreasing temperature. For this reason it is necessary and preferred to keep the treatment material to be dried at the highest possible, but not product-damaging level. In this respect, the heat produced as mentioned above during the water deposit in the adsorbents within a special adsorber arrangement is supplied to the material to be dried. The transfer to the treatment material can occur for example via tube coils in the treatment space, the aforementioned heatable double jacket, and/or the heatable stirrer arms in a rigid or rotating vacuum container.

The efficiency in the vacuum container or the adsorber apparatus can be influenced in an energy-saving manner within the terms of rapid and effective drying by controlling the respective temperatures in the vacuum drying container or the adsorber apparatus, by exchanging cooling or tempering media via a respective circuit and controlling means.

In contrast to the known freeze-drying, the treatment material can be dried in accordance with the invention in a very small space, wherein the shifting movements ensure that the surface of the material is subjected to uniform drying.

It can also be considered that double-wall tempered plates which are covered with the treatment material are used. A germ-reducing treatment by plasma or pulsed light can be carried out during or after the drying process.

The treatment space can be arranged as a conventional vacuum tumbler, vacuum mixer or any other container that can be evacuated, in which the treatment material is subjected to slow shifting or movement. The deployed container shall ensure a high drying rate by supplying heat to the treatment material during vacuum drying.

A vacuum-container drying space with means for introducing and discharging the treatment material is provided in the device in accordance with the invention for processing raw materials and effectively producing raw cured goods on the basis of meat and sausage by means of a drying and ageing process together with the addition of starter cultures, wherein the raw material or an already available intermediate product is exposed to a vacuum. A vacuum tumbler or vacuum mixer is preferably provided as a drying space.

The vacuum-container drying space can be brought into connection with an evacuated adsorber via a first valve arrangement. Furthermore, the adsorber is coupled via a second valve arrangement to a condenser, wherein the adsorber adsorbs the water vapour released in the vacuum-container drying space after the opening of the first valve arrangement. The adsorber is formed in a coolable and heatable manner for setting the water vapour pressure.

In an appropriate embodiment of the invention, several adsorbers with associated valve arrangements can be connected to a vacuum-container drying space and can be operated in a phase-shifted or anticyclic manner.

The adsorber or adsorbers can be formed as zeolite-coated heat exchangers and can be cooled or heated by a heat transfer fluid.

In a further embodiment of the invention, all regions of the device that can potentially come into contact with the treatment material are provided with an antimicrobial coating, e.g. an antimicrobial powder lacquer.

Furthermore, means for producing a dielectric barrier discharge for the purpose of inactivating microorganisms can be provided. A low-temperature plasma, which is also known as a cold plasma, is produced by means of said alternating-voltage gas discharge, which plasma is used for surface disinfection and is superior to the partly used disinfection agents, which in addition are not odourless or tasteless.

The invention will be explained below in closer detail by reference to an embodiment and a drawing.

The drawing shows the principal structure of an adsorptive vacuum dryer in accordance with the invention.

Humid substances such as foodstuffs can be dried by adsorption of water vapour in an effective manner by means of the sorptively supported vacuum dryer, which is shown in the drawing in its fundamental layout, so that a more rapid and energy-saving drying process is obtained.

Especially when exhaust heat is generated during the subsequent or accompanying production steps, a regeneration of the adsorbent or adsorbents can be carried out in an energy-saving manner.

The exemplary device according to the drawing is based on an adsorber 1, which is formed as a zeolite-coated heat exchanger and which can be heated or cooled by a heat transfer medium such as water or air.

The drying material 2 is disposed within a vacuum-container drying space 3. The respective container 3 can be provided for charging with a simple vacuum flange, but also with a transfer port system in order to avoid regular post-evacuation.

The vacuum-container drying space 3 is in connection with the adsorber 1 via a first valve arrangement 5. The adsorber 1 is coupled to a condenser heat exchanger 4 via a further valve arrangement 6, which heat exchanger can be cooled by means of a heat transfer medium such as water or air.

The valve arrangement or container separation 5; 6 can be formed in a switchable manner or automatically as a non-return flap within the terms of a flap valve. The separation per se can be realised as a relatively thin, intrinsically stable sheet-metal material, because both the vacuum-container drying space 3 and also the adsorber 1 are evacuated. The container separation with the valve between the adsorber space 1 and condenser space 4 can be realised in a switchable manner or automatically as a non-return flap. In this case too, the spatial separation can be realised via an intrinsically stable sheet-metal material because the device components 3 and 1 are under vacuum. A lower valve cross-section can be considered with respect to the first valve arrangement due to the higher water-vapour density present in the second valve arrangement.

Condensate is removed from the space with the condenser heat exchanger 4 via a transfer port 7. A connection to a vacuum pump is shown with reference numeral 8.

The exterior housing, which comprises the adsorber, vacuum-container drying space and condenser heat exchanger, can fundamentally be realised as a common casing with respectively thinner intermediate walls with reference to the arrangement that is under vacuum in its entirety.

The mode of operation of the device in accordance with the invention will be explained below.

The material to be treated, i.e. the drying material, is introduced at first into the vacuum-container drying space 3. Moisture is evaporated after the application of a vacuum, especially water. This is followed by the opening of the first valve arrangement 5, or the valve opens itself, which occurs as a result of the occurring pressure difference. The previously regenerated adsorber 1 absorbs the released water vapour.

Once the adsorber 1 is saturated with water vapour, the first valve arrangement 5 is closed or closes itself, since the pressure difference is removed. In order to achieve maximum capacity, the adsorber 1 is cooled. The minimum achievable water vapour pressure can be set via the selection of the cooling temperature, so that in the event that a specific degree of drying must not be exceeded a respective balance will be obtained more or less automatically.

The adsorbed water vapour is released by means of heating the adsorber 1. A regeneration of the adsorber or adsorbents occurs in this case. The water vapour reaches the condenser 4 after the opening of the second valve arrangement or a respective non-return flap respectively provided there.

Condensation of the released water vapour occurs by cooling the condenser 4. The condensate is removed via the vacuum lock 7.

The process explained above can be repeated until the respective degree of drying of the treatment material 2 has been reached.

If quicker drying is desired, several adsorbers 1 with associated valve arrangements 5 and 6 can be connected to the drying space 3 and the condenser space 4 and can be operated in this respect in an anticyclic or phase-shifted manner. The energy input for the regeneration of the adsorbents can be reduced even further by useful heat reclamation between the deployed adsorbers.

The condensation and adsorption heat released during the process at a lower temperature can be used in accordance with the invention for the careful heating of the drying material.

Water vapours, which are to be achieved at a minimum and which should not fall beneath said minimum, can be predetermined by setting the temperatures in regeneration and/or adsorption. This default value can also be adjusted during the drying phase by changing the temperatures. Especially careful drying of the drying or treatment material is thus possible.

The deployed device may concern a vacuum tumbler or a vacuum mixer or the like as already mentioned above, in which the treatment material is subjected to slow movement or can be stored in very thin layers.

The treatment space thus comprises an opening which can be sealed in a vacuum-tight manner and via which the treatment material can be introduced and discharged. The possibility for respective cleaning of the device is provided by said opening.

If continuous treatment is desired, the treatment material can be introduced into and removed from the vacuum-container drying space via a vacuum lock.

The treatment device is in connection with its special evacuated adsorbers which contain adsorbents via pipe connections and valve arrangements.

A separation under vacuum from the treatment space is advantageous for regenerating the adsorbers, so that water stored in the adsorbents can be driven out by a heat transfer fluid. For this purpose, a similarly evacuated cold trap is connected to the adsorber, so that vapour produced by the subsequent heating within the adsorber can deposit on the cold surfaces of the cold trap for such a time until the reuse of the respective adsorber for dehumidifying is possible.

The water collected in the cold trap is removed after the separation or decoupling from the adsorber which occurred under vacuum.

The adsorbents should be kept continually under vacuum in the adsorber boxes for the purpose of avoiding unnecessary evacuation measures. This means that the treatment space or the cold trap have a similar vacuum level prior to the connection or coupling to the respective adsorber.

Salt can be added for improving the transport of water out of the treatment material. Although it is water-absorbent, the salt acts as a transport aid. In an embodiment of the vacuum-container drying space without germ-reducing apparatuses, the addition of starter cultures and seasoning mixtures for the preparation of raw sausage meat can already occur during the drying phase. It is desirable in this case to ensure the quickest possible further processing such as crushing, filling, ageing and the like.

The subsequent summary in the table shows the result of an adsorption test with raw sausage/silica gel, with the silica gel as the adsorbent. The basic sausage meat was pork in the composition of 75:25, i.e. relatively lean and minced, which was admixed with 28 g/kg of nitrite pickling salt. The pre-crushed sausage meat was weighed precisely and added to a desiccator. Weighed dried silica gel was used as the adsorbent.

The entire system is then evacuated and the vacuum is maintained over the entire treatment period.

In the test set up, the desiccator was placed in a cold water bath so that the deployed silica gel was subjected to cooling for maintaining the water absorption readiness. The exemplary procedure was limited to four hours.

As a result, the changed weight data of the sausage meat and the silica gel were determined.

The result in cool silica gel shows especially positive results and thus confirms the principal advantageous applicability of the method in accordance with the invention.

In a further development of the teachings of the invention, it is possible to optimise the absorbance and storage of moisture, and water in particular, in such a way that so-called porous glasses are used. The optimum of moisture storage capacity can be realised via the setting of the pore size, pore volume and particle shape. Deployed porous glasses are capable of absorbing and storing water in vapour form, and discharging the moisture after a given period of time. The advantage of porous glasses lies further in the non-toxicity and the fact that they are not combustible.
Adsorption test raw sausage/silica gel
Basic sausage meat: pork 75/25 minced and admixed with 28 g/kg NPS
Desiccator: room temperature
Meat test sample: 250.80 g
Silica gel test sample: 50.20 g
Result after 4 h at 20° C.:
Meat weight: 249.60 g
Silica gel weight: 51.20 g
Loss in the meat: 0.48%
Increase in silica gel: 1.99%

Vacuum cabinet:
Meat test sample: 401.80 g
Silica gel test sample: 80.00 g
Result after 4 h at 20° C.: (silica gel was situated on frozen accumulators)
Meat weight: 381.00 g
Silica gel weight: 91.20 g
Loss in the meat: 5.18%
Increase in silica gel: 14.00%

1. A method for processing raw materials and effectively producing raw cured goods on the basis of meat and sausage by means of a drying and ageing process together with the addition of starter cultures, wherein the raw material or an already available intermediate product is exposed to a vacuum, characterized in that moisture, especially water or water vapour, released during the treatment under vacuum is bound by means of adsorbents in order to accelerate the drying process, and the adsorption process occurs in one or more stages depending on the desired degree of drying or the a_{w} value of the raw material or intermediate product.

2. A method according to claim 1, characterized in that exhaust heat from subsequent or technologically accompanying raw-material process treatment steps are used for the regeneration of deployed adsorbents.

3. A method according to claim 1, characterized in that released condensation and adsorption heat is used for the careful heating of the raw material or the intermediate product.

4. A method according to claim 1, characterized in that the raw material or the intermediate product is partly enclosed in order to achieve selective drying and a respective extraction of moisture.

5. A method according to claim 1, characterized in that the treatment material is introduced into a vacuum tumbler or vacuum mixer and is subjected to shifting during the treatment, wherein moisture is extracted from the treatment material by the applied vacuum, and further the occurring evaporation cooling is used for cooling the deployed adsorbents and the heat released by the attachment of the moisture on the adsorbents is used for heating the treatment material in the vacuum tumbler or vacuum mixer, so that the release of moisture from the treatment material is subjected to acceleration.

6. A method according to claim 5, characterized in that an inactivation of undesirable microorganisms occurs during treatment by means of antimicrobial coating of the deployed apparatuses and/or dielectric barrier discharge and/or radiation treatment.

7. A device for processing raw materials and effectively producing raw cured goods on the basis of meat and sausage by means of a drying and ageing process together with the addition of starter cultures, wherein the raw material or an already available intermediate product is exposed to a vacuum, characterized in that a vacuum-container drying space (3), especially formed as a vacuum tumbler or vacuum mixer, is provided with means for introducing and discharging the treatment material, wherein the vacuum-container treatment space (3) is in connection via a first valve arrangement (5) with an evacuated adsorber (1), and further the adsorber (1) is coupled via a second valve arrangement (6) to a condenser (4), wherein the adsorber (1) adsorbs the water vapour released in the vacuum-container drying space (3) after the opening of the first valve arrangement (5), and the adsorber (1) is formed to be coolable and heatable for setting the water-vapour pressure.

8. A device according to claim 7, characterized in that several adsorbers (1) with associated valve arrangements (5; 6) are connected to the vacuum-container drying space (3) and can be operated in a phase-shifted or anticyclic manner.

9. A device according to claim 7, characterized in that the adsorber or adsorbers (1) are formed as zeolite-coated heat exchangers and are coolable or heatable by a heat transfer fluid.

10. A device according to claim 7, characterized in that all regions that may potentially come into contact with the treating material are provided with an antimicrobial coating.

11. A device according to claim 7, characterized in that means are provided for the generation of or for the treatment with a dielectric barrier discharge for the inactivation of microorganisms.
